(19) United States
(12) Patent Application Publication
(10) Pub. No.: US 2005/0191419 A1
(43) Pub. Date: Sep. 1, 2005

(54) Fabrication of nanostructures

(76) Inventor: James M. Helt, Staten Island, NY (US)

Correspondence Address: EVAN LAW GROUP LLC, 566 WEST ADAMS, SUITE 350, CHICAGO, IL, 60661, US

(21) Appl. No.: 10/821,403

(22) Filed: Apr. 8, 2004

Related U.S. Application Data
(60) Provisional application No. 60/462,049, filed on Apr. 11, 2003.

(51) Int. Cl. B05D 5/00; B44C 1/22

(52) U.S. Cl. 427/256; 216/41

(57) ABSTRACT

Nanostructures and methods of forming nanostructures, including nanowires, are disclosed. The methods involve deforming a film by compressing a stamp into a film. This deformation and the structure and geometry of the stamp may provide channels with energetically favorable and unfavorable interfacial interactions, enabling the selective transport of a chemical reagent through the channels. Various aspects of the relation of stamp geometry to the types of nanostructures that may be formed and the placement of these nanostructures are also disclosed. Nanostructures incorporating multi-dimensional patterned architectures are also disclosed.

### CROSS REFERENCE TO RELATED APPLICATIONS

This application claims priority to U.S. Provisional Application No. 60/462,049, filed Apr. 11, 2003, entitled “Fabrication of Nanostructures,” the entire contents of which are incorporated herein by reference.

### BACKGROUND

The field of nanotechnology has evolved out of the desire to maintain Moore's law, which states that the storage capacity of silicon based integrated circuits should double every eighteen months. Other fields such as micro-electromechanical systems (MEMS), photonics, displays for cellular phones, and personal media have benefited from the semi-conductor industries technological breakthroughs.

The diffraction limit of the light presently used in photolithography threatens to prevent conventional methods from forming sub-100 nanometer (nm) structures. Thus, alternative technologies for the fabrication of nanostructures, including, but not limited to nanowires and nanoarrays, are needed to replace or augment conventional lithographic techniques for the fabrication of semiconductors.

Alternative technologies have emerged that may produce sub-100 nm structures. These methods include electron beam lithography, X-ray photolithography, extreme ultraviolet photolithography, focused ion beam, microcontact printing, nanoimprint lithography, as well as variants of the serial scanning probe microscopy nanolithographies (e.g. dip-pen nanolithography). Advances in these fields may eventually lead to higher density semiconductor chips with smaller circuits having faster computational speed and signal transfer.

However, each of these existing technologies has disadvantages. While X-ray photolithography may be a promising avenue for large volume mass production of sub-100 nm structures, the direct write photomasks required for parallel processing are very expensive. Furthermore, the production of sub-100 nm structures is difficult to achieve in a parallel manner. Alternative methods for generating low cost X-ray masks would be beneficial.

It would be desirable to have a method for the fabrication of metal, ceramic, and polymeric nanostructures. It would also be beneficial to have a process for making these structures that was easy to scale up and suitable for industrial scale manufacturing. The present invention overcomes at least one disadvantage of prior nanofabrication methods by providing a more direct method involving fewer processing steps, and affords both a greater range of structural size and the ability to further manipulate the product geometries.

### SUMMARY OF THE INVENTION

The present invention relates to nanostructures and the fabrication of nanostructures, such as nanowires and nanoarrays. In one aspect, the synthesis of the nanostructures may include the mechanical deformation of a film combined with the chemical modification of the film. Mechanical deformation may be provided by contacting and compressing a stamp having raised and recessed regions into the film. Optionally, the deformed material may be transferred to a support. In another aspect, the present invention may include stamps and the production of stamps that include embedded nanostructures that may be placed on a photoresist and irradiated.

The resultant nanostructures and the nanoscale production methods utilized to produce them may beneficially be used in catalysis, soft lithography, sensors, elements for the construction of nanocircuits, photonics, displays, X-Ray stencils, band-gap devices, and nanocomputers, for example.

Other systems, methods, features and advantages of the invention will be, or will become, apparent to one with skill in the art upon examination of the following figures and detailed description. It is intended that all such additional systems, methods, features and advantages be included within the description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like references numerals designate corresponding parts throughout the figures.

FIG. 1 illustrates a procedure for fabrication of nanostructures embodying aspects of the present invention.

FIG. 2 illustrates an exemplary procedure illustrating several products fabricated according to the invention.

FIG. 3 illustrates a procedure embodying aspects of the present invention where a nanostructure of the present invention is used as a mask for a lithographic process.

FIG. 4 illustrates a procedure for the directed transfer of a nanostructure to a support embodying aspects of the present invention.

FIG. 5a illustrates a stamp having sloped sidewall geometry (“saw tooth”) with the angle of sidewall slope depicted by a dashed line.

FIG. 5b illustrates a stamp having “rectangular” sidewall geometry.

FIG. 6 illustrates a compression cell having planar compression plates as may be utilized to fabricate nanostructures in accordance with the present invention.

FIG. 7 illustrates a compression cell having curved compression plates as may be utilized to fabricate nanostructures in accordance with the present invention.

FIG. 8 depicts nanostructures embodying aspects of the present invention where gold nanowires were fabricated and then transferred to a support already possessing gold wires to create a gold crosshatch pattern.

FIGS. 9a-b depict nanostructures embodying aspects of the present invention where a three-layer gold nanowire crosshatch was fabricated by the successive transfer of nanowires to a support.

FIG. 10 depicts nanostructures embodying aspects of the present invention where gold nanowires were fabricated on the raised regions of a stamp and gold nanowires also were fabricated within the recessed regions of the stamp.

FIG. 11 depicts nanostructures embodying aspects of the present invention where gold nanowires were fabricated on the raised regions of a stamp and colloidal latex beads were deposited in the recessed regions of the stamp for illustrative purposes.

FIG. 12 depicts nanostructures embodying aspects of the present invention where gold nanowires are fabricated whose width varies radially.

### DETAILED DESCRIPTION

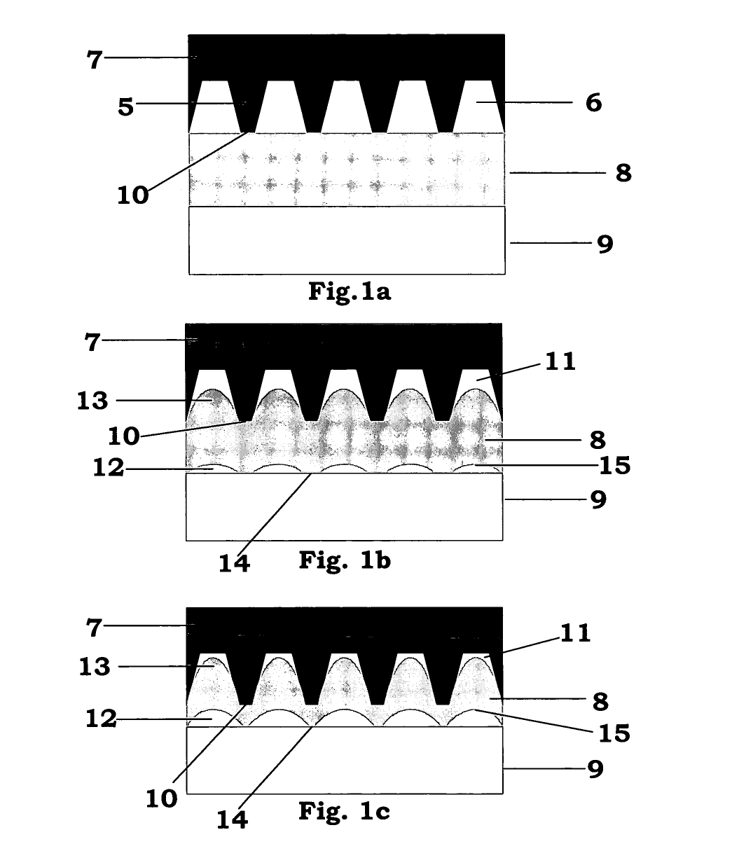

FIGS. 1a-c illustrate a preferred process for fabricating nanostructures, such as nanowires, in accordance with the present invention. In FIG. 1a, stamp 7 may be contacted with film 8, which may reside on an optional supporting substrate 9. The stamp 7 may possess one or a plurality of raised regions 5 and one or a plurality of recessed regions 6. At least one of the raised regions 5 may form a contact 10 with the film 8. The raised and recessed regions may alternate continuously in one, two, and/or three dimensions or their alternating pattern may stop and restart in a different position, thus being discontinuous in one or more of the three dimensions. As used in the specification and appended claims, “on” includes when films are adjacent to the supporting substrate and when films are separated from the supporting substrate by one or more intervening films or layers.

The smallest feature dimension of the stamp 7 is preferably from 1 to 5000 nm. More preferably, the smallest feature dimension of the stamp 7 may be from 20 to 1000 nm. A feature dimension of the stamp is defined as the distance from one portion of a raised region to the same portion of an adjacent raised region. In addition to the smallest feature dimension, the stamp 7 may include features having dimensions that are significantly larger than the smallest feature dimension.

The stamp 7 may be made from any material or combination of materials having sufficient mechanical strength to bring about deformation of the film 8. In one aspect, materials having a Young's Modulus of at least 10⁷ Pascal (Pa) are used. In a preferred aspect, materials having a Young's Modulus from 10⁸ to 10¹⁰ Pa are used. At present, materials having a Young's Modulus of from 2 to 4×10¹⁰ Pa, more preferably from 2.2 to 3.5×10¹⁰ Pa, are preferred.

Polymer materials for use in the stamp 7 may include thermoplastic polymers, thermosetting polymers, polymer composites, polyethylene, polystyrene, poly(methyl methacrylate), polybutadiene, polypropylene, and combinations thereof in either amorphous or crystalline states. Preferable polymers for use in the stamp 7 include polycarbonate, polyethylene, polystyrene, poly(methyl methacrylate), polypropylene, polybutadiene, their derivatives, and their co-polymers. More preferable polymers for use in the stamp 7 include polyimide, polyphenylene oxide, polyethylene oxide, TEFLON, polydimethylsiloxane, polypropylene, as well as conductive polymers such as polythiophene, polypyrrole, and polyacetylene. Especially preferred polymers for use in the stamp 7 at present include polycarbonate, polystyrene, poly(methyl methacrylate), and polybutadiene as available, for example, from Aldrich (Milwaukee, Wis.) and Scientific Polymer Products Inc. (Ontario, N.Y.).

The material or materials from which the stamp 7 is formed may include inorganic constituents or compositions. Such stamp materials also may be a composite material that includes polymers, thermosetting polymers, co-polymers, silica particles, alumina particles, silicon nitride particles, tungsten carbide particles, silicon carbide particles, gold, tungsten, tantalum, metal oxide particles, ceramic particles, or combinations thereof.

The stamp 7 may be substantially planar, as illustrated in FIGS. 1a-c, or non-planar. Non-planar stamp architectures may include cylinders, cubes, pyramids, wheels, helix, discs and polygons, and the like. Furthermore, the geometry of stamp 7 may be symmetric or non-symmetric, thus possessing multiple sides of different geometries. Similarly, stamp 7 may be in the form of a disc, which is able to rotate, thus allowing continuous asymmetric or symmetric surface patterning in accordance with this invention.

The film 8 may be any mechanically deformable material, including a polymer, metal, amorphous film of organic and/or inorganic molecules, ceramic, semiconductor, alloy, self-assembled monolayer of organic and/or inorganic molecules, or combination thereof. The film 8 may include materials in the solid, gel, and/or liquid phase. At present, an especially preferred material for the film 8 includes gold and its alloys.

The supporting substrate 9 may be a solid polymer, ceramic, metal, alloy, semiconductor, or glass; a porous or nanoporous ceramic, glass, semiconductor, polymer, or thermoset; other nanoporous materials; a halogenated polymer; a gel; or any combination thereof. The term “porous” refers to hollow regions within a material having an average internal diameter from 0.1 micrometer (μm) to 1 μm. The term “nanoporous” refers to hollow regions within a material having an average internal diameter from 1 nm to 99 nm. The supporting substrate 9 may more preferably include silicon, mica, aluminum oxide, indium tin oxide, highly oriented pyrolytic graphite, and/or glass. At present, an especially preferred material for the supporting substrate 9 is muscovite mica available from Structure Probe Inc., West Chester, Pa.

The supporting substrate 9 is not required to be planar, as illustrated in FIGS. 1a-c, but may include other geometries such as a cylinder, cube, pyramid, wheel, helix, disc, polygon, or any combination of such geometries. In one aspect, the geometry of the stamp 7 may depend on the geometry of the film 8, which may depend on the geometry of the supporting substrate 9.

The surface of the supporting substrate 9 may be modified with one or more resist materials that may allow for additional photolithographic patterning of substrate 9 after formation of the nanostructures. Subjecting portions of the substrate 9 to a magnetic field can align magnetic materials on the resulting products. Subjecting portions of the substrate 9 to an electric field also can modify the resulting width of the resulting nanostructures. Subjecting the substrate 9 to radiation or chemical reagents to chemically modify the surface energy of the materials can facilitate or inhibit nanostructure formation. Subjecting the film 8, stamp 7 and/or substrate 9 to sonication can clean the stamp and nanostructures as well as provide a means of separating the stamp 7 from the nanostructure products.

FIGS. 1b-c illustrate an example of what may occur as force is exerted on the stamp 7 during a stamping procedure. During the stamping procedure force is exerted on the stamp 7, thereby, causing the mechanical deformation of the film 8. In one aspect, the stamp 7 may expand laterally when compressed into the film 8. In another aspect, the stamp 7 may undergo an elastic expansion when compressed into the film 8.

As force is applied to the film 8 at the contact 10, concave down buckling at 15 may be contiguous to the compressive stress centered at 14. In combination, this localized buckling can create a lower channel 12, which may be formed between the underside of the film 8 and the supporting substrate 9. Upper channel 11 also may be formed from deformation and/or compression of the film 8 at the contact 10 to form a buckled film surface 13 in the recessed region 6 of the stamp 7. The upper channel 11 may be defined as a region encompassed by the inner walls of stamp 7 and the buckled film surface 13. Multiple upper and lower channels, 11 and 12, respectively, may be formed in this manner.

In one aspect, the force exerted on the stamp 7 may be from 10⁵ to 10¹⁰ Pa. In a preferred aspect, when the stamp 7 is a polymer and the film 8 is a metal, the force applied to the stamp 7 may be from 10⁶ to 10⁸ Pa. In one aspect, the force exerted on the stamp 7 is about 380×10⁶ Pa. At present, the force exerted on the stamp 7 is preferably greater than the yield stress of the film. In this manner the stamp 7 may completely penetrate or cut through the film 8. In one aspect, the nanostructures may have their average cross-sections modulated by varying the force applied to the stamp 7. In the specification and appended claims, the term average cross-section is the average of the width or height dimension of the formed nanostructures.

As the force applied to the stamp 7 increases, so will the degree of deformation that occurs in the film 8. Therefore, the aspect ratio, defined as the ratio of nanostructure height to width, can be adjusted with the force applied to the stamp 7. The radial distribution of elastic and/or plastic forces acting at the contacts 10 between the stamp 7 and the film 8 may allow for the fabrication of nanostructures whose width can vary radially from the center of contact, as will be discussed in greater detail with regard to FIG. 7. The force required to form a nanostructure having a given height and width may be estimated using several theories known to those of ordinary skill in the art. A detailed treatment of these theories may be found in H. Hertz, et al., J. Reine Angew. Math., p. 156 (1881) (Hertzian theory of elastic compression); K. L. Johnson, Contact Mechanics, p. 125 (1987)) (contact mechanics theories).

The structure resulting from the stamping procedure, a combined stamp/film/supporting substrate “sandwich” may then be immersed or exposed to a chemical reagent (not shown), such as an etchant. For example, if the film 8 is metal, a metal etchant may be used to dissolve or react with a portion of the metal film. The chemical reagent may be a liquid, gas, solution, gel, dispersion, and/or slurry and may be allowed to diffuse, or may be alternately forced, through the upper and/or lower channels. In this manner, portions of the film may be removed through the etching process.

The upper and lower channels may have distinct surface energies or surface tensions in response to the materials from which the stamp 7, the film 8, and the supporting substrate 9 are fabricated. The surface energies and/or surface tensions of the channels may be affected by their hydrophilic character, hydrophobic character, mechanical forces, and the like. These mechanical forces may include a tangential sheer stress generated by the lateral expansion of the stamp when compressed.

The type of interaction the chemical reagent has with the surface energies of the channels 11, 12 may be referred to as an anisotropic interaction. Thus, the selective reaction of a chemical reagent with the film 8 in the lower channel 12 may occur, while the chemical reagent is substantially excluded from the upper surface of the film 8 present in the upper channel 11. In one preferred aspect, the upper channel 11 or the lower channel 12 may be etched to the substantial exclusion of the other.

For example, if the stamp 7 is a hydrophobic material (e.g. plastic), the film 8 is a metal (e.g. gold), and the supporting substrate 9 is a hydrophilic material (e.g. oxidized Si or muscovite mica), a water based (hydrophilic) etchant may be used to favor etching the concave down portion 15 of the metal above the lower channel 12, while substantially excluding etching in the upper channel 11. Thus, when the supporting substrate 9 is hydrophilic in nature, the stamp is less-hydrophilic in nature, and a water-based etchant is utilized, etching may selectively occur at a more rapid rate in the lower channel 12. Conversely, a hydrophilic etchant may selectively etch in the upper channel 11 in a more rapid manner, to the substantial exclusion of the lower channel 12. Furthermore, as the etching process continues, the film 8 may be pushed further into the upper channel 11 of the stamp 7, as is illustrated in the progression from FIG. 1b to FIG. 1c.

Due to the many combinations of hydrophilic and less-hydrophilic materials that may be used as the stamp 7, the film 8, the supporting substrate 9, and the etchant, many variations are possible within the scope of the invention. Thus, one of ordinary skill in the art may maximize the likeness or difference between the surface energies of the upper and lower channels, 11 and 12, respectively, to facilitate a substantially channel selective processes.

Many types of nanostructures may be fabricated using the basic methodology represented by FIG. 1 due to the ability to simultaneously control multiple variables. These variables include the extent of etching; the technique used to separate the stamp 7 from the supporting substrate 9; and the adhesive and mechanical forces acting at the contacts 10 between the stamp 7 and the film 8, and between the film 8 and the supporting substrate 9. These and other variables may be controlled through the selection of the materials used, the pressures applied to the stamp 7, and/or the chemical reagent, as would be known to one of ordinary skill in the art.

For example, adjusting the solvent composition of the chemical reagent can determine whether both the upper and lower channels 11, 12 or one of the channels preferentially undergoes chemical reaction. Adjusting the temperature during fabrication can increase the rate of structure formation and influence the organization and average cross-section of the resultant nanostructures. Adjusting the geometry of the raised region 5 in the stamp 7 can direct the placement of the nanostructures on the stamp 7 and/or on the supporting substrate 9. Adjusting the geometry of the recessed region 6 in the stamp 7 also can direct the placement of the nanostructures on the stamp 7 and/or on the supporting substrate 9. Adjusting the force applied to the stamp 7 can influence the average cross-section of the nanostructures formed on the stamp 7 and/or the supporting substrate 9. Changing the material of the stamp 7 may influence the average cross-section of the nanostructures formed on the stamp 7, may influence the dimensions of the nanoscopic deformations that the stamp itself undergoes during compression, may influence the dimensions of the nanoscopic deformations of the film 8 during compression, may influence the adhesion of the formed nanostructures to the stamp 7, and may influence the optical properties of the stamp 7. Changing the material of the film 8 can vary the resulting materials to be patterned. Adjusting the materials of the supporting substrate 9 may change the physiochemical interactions with the film 8 and may influence the average cross-section and placement of the formed nanostructures.

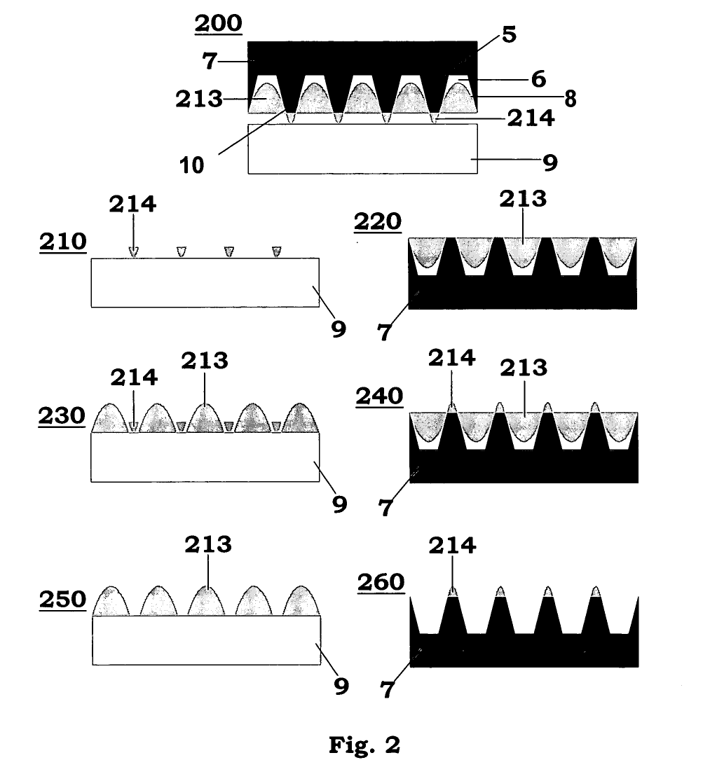

FIG. 2 illustrates a variety of nanostructures that may be fabricated in accordance with the present invention. When a nanostructure fabrication procedure, such as previously discussed with regard to FIG. 1, is complete, the location of fabricated nanostructures 213 and 214 are shown in structure 200. The nanostructures 213 and 214 may be portions of the film 8 that where not removed by the etchant.

The nanostructure 214 may be formed at the point of contact 14 between the stamp 7 and the film 8 (FIG. 1c). The nanostructure 213 may be formed within the recess region 6 of the stamp 7 (FIG. 1a). In one aspect, the nanostructure 213 may have an average cross-section that is larger than the nanostructure 214. In another aspect (not shown), the nanostructure 214 may have an average cross-section that is larger than nanostructure 213. Furthermore, the average cross-sections of the nanostructures 213 and 214 may be substantially equal. In one aspect, the average cross-section of the resulting nanostructures may range from 1 nm to 1 μm, preferably from 1 nm to 500 nm, and more preferably, from 1 nm to 100 nm. At present, preferred nanostructures have average cross-sections from 500 nm to 1 μm or less than 120 nm.

Upon separation of the stamp 7 from the supporting substrate 9, structures 210, 220, 230, 240, 250, and 260 may result. The average cross-section and placement of the nanostructures, including 213 and 214, may depend on processing variables, such as the extent of etching and the load applied to modulate and control nanostructure size. Furthermore, the size and placement of the nanostructures may depend on the geometry, such as the sidewall slope, of the raised and recessed regions 5 and 6 and the technique used to separate the stamp 7 from the supporting substrate 9.

Local chemical and physical forces acting at the interfaces between the supporting substrate 9 and the nanostructure 214; between the stamp 7 and the nanostructure 214; and between the stamp 7 and the nanostructure 213, for example, also may direct placement of nanostructures. Local chemical and physical forces may include magnetic forces, electrostatic forces, dipole-dipole forces, van der Waals forces, and mechanical forces. Upon separation of the stamp 7 from the supporting substrate 9, these and other local forces may determine whether the fabricated nanostructures remain on the supporting substrate 9, and/or on the stamp 7, and/or embedded in the recessed regions of the stamp 7. The structures 210, 220, 230, 240, 250, and 260 provide examples of how the presently claimed invention can form a plurality of unique nanostructures from a single stamping procedure.

The structure 210 illustrates the type of nanostructures that may be fabricated when etching has not completely removed portions of the film 8 at the contact 10. By controlling etching in this manner, the nanostructures 214 may be fabricated. Because stronger local forces exist between the nanostructure 214 and the supporting substrate 9 than between the nanostructure 214 and the stamp 7, when separated, the nanostructure 214 remains on the supporting substrate 9.

The structure 220 illustrates the type of nanostructures that may be fabricated when etching has not completely removed the film 8 from the recessed region 6 of the stamp 7. In this aspect, the nanostructure 213 is fabricated. Because stronger local forces exist between the nanostructure 213 and the stamp 7, than between the nanostructure 213 and the supporting substrate 9, when separated, the nanostructure 213 remains embedded within the recessed region 6 of the stamp 7.

The structure 230 illustrates the type of nanostructures that may be fabricated when etching has not completely removed portions of the film 8 from the contact 10 and from the recessed region 6 of the stamp 7. Because stronger local forces exist between the resulting nanostructure 213, 214 and the supporting substrate 9, than between the nanostructures 213, 214 and the stamp 7, when separated, the nanostructures 213, 214 remain on the supporting substrate 9. Similarly, the structure 240 illustrates the type of nanostructures that may be fabricated when incomplete etching at the contact 10 and the recessed region 6 is coupled with stronger local forces existing between the nanostructures 213, 214 and the stamp 7. The structures 250 and 260 illustrate the type of nanostructures that may be fabricated when incomplete etching at the contact 10 and the recessed region 6 is coupled with strong local force existing between the nanostructure 213 and the supporting substrate 9 and between the nanostructure 214 and the stamp 7.

FIG. 3 illustrates an exemplary procedure illustrating the use of a stamp assembly 300 that includes an embedded nanostructure 313 as a mask for photolithography. The stamp assembly 300 may be placed on a photoresist 318. The stamp assembly 300 may include a transparent stamp 307 and an opaque nanostructure, such as the nanostructure 313. When radiation 315 is introduced to the stamp assembly 300, the opaque nanostructure 313 of the stamp assembly 300 substantially prevents a portion of the radiation 315 from reaching the photoresist 318. Thus, the chemical or physical change that the radiation 315 would otherwise bring about at the surface of the photoresist 318 does not substantially occur in the regions under the nanostructure 313. In the areas of the photoresist 318 not protected by the nanostructure 313, the radiation 315 may bring about chemical or physical changes that may make the irradiated portions of the photoresist 318 more or less prone to dissolution, further chemical reaction, and the like.

For example, if irradiation makes the photoresist 318 more susceptible to dissolution, removing the irradiated portions of the resist can lead to a pattern on substrate 319, which resembles the structure or pattern of the nanostructure 313. A working distance 317, defined as the distance between the surface of the photoresist 316 and the surface of the stamp assembly 300, can be adjusted with a stepper, micropositioner, or piezoelectric translator. The approximately coplanar arrangement of the nanostructure 313 with the surface of the stamp 307 allows a very small working distance 317 to be achieved by placing the stamp assembly 300 on the resist 318. In this aspect, the stamp assembly 300 may be used as a close proximity photomask.

A multiplicity of structures and nanostructures, including those illustrated in 200, 210, 220, 230, 240, 250, and 260 of FIG. 2, may be preferably used as masks for lithographic techniques, including X-ray and EUV photolithographies, for example. When the substrate 319 is flexible, such as if made from a flexible polymer, the substrate 319 may function as a low-cost 1:1 X-ray photomask. Preferably, the working distance between the photomask and the material to be patterned is less than 5 μm. Larger working distances may be preferred when diffraction effects are desirable to form more complex patterns.

In another aspect, the nanostructure 313 can interact with the radiation 315, which may permanently or transiently alter the chemical or physical properties of the nanostructure 313. By altering the properties of the nanostructure 313, a chemical or physical change may be induced in the resist 318. For example, if the stamp assembly 300 is in contact with the resist 318 when the radiation 315 is applied, local heating of the nanostructure 313 may occur. This local heating can selectively transfer heat to the regions of the resist 318 that are in direct contact with the nanostructure 313. The selectively heated regions of the resist 318 may undergo chemical or physical changes that enable the selectively heated regions to selectively dissolve, and the like. While other types of radiation are possible for selective heating, microwave, infrared, radio frequency, or combinations thereof are preferred.

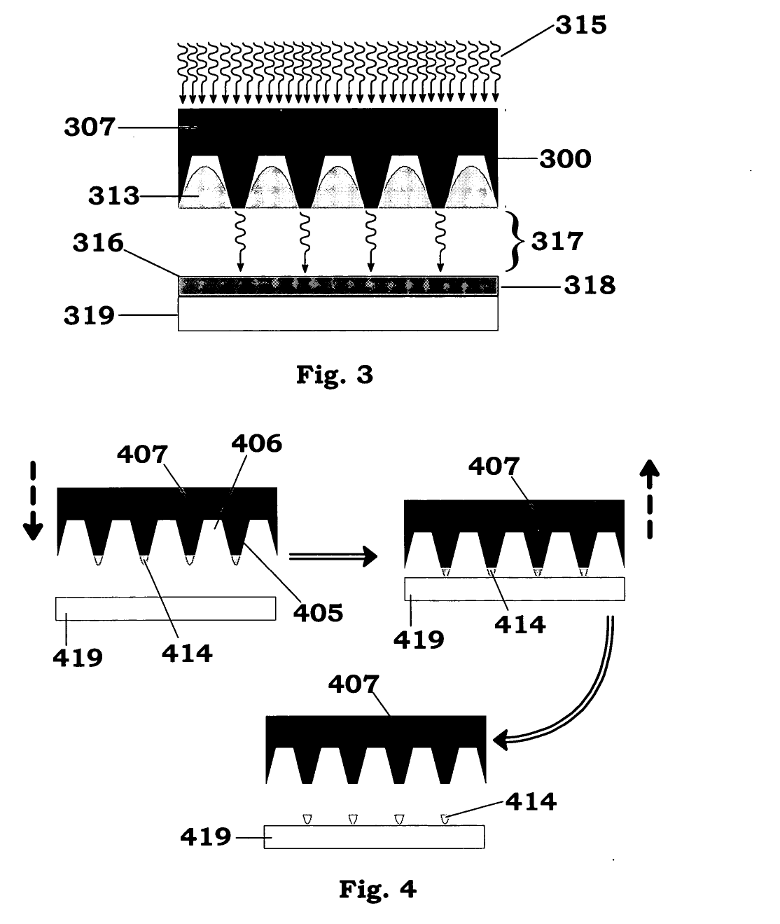

FIG. 4 illustrates an exemplary procedure for the directed transfer of nanostructures 414 to a support 419. Stamp 407 includes the nanostructures 414 residing on the raised regions 405 of the stamp 407. Directed transfer of the nanostructures 414 onto the support 419 may be accomplished by moving the stamp 407 into and then out of contact with the support 419.

Which nanostructures transfer to the support 419 may be controlled by selecting the materials and methods so that stronger local forces exist between the nanostructures desired for transfer and the support 419 than between the nanostructures and the stamp 407. For example, the nanostructure 213, as shown in structure 220 of FIG. 2, may be transferred to the support 419 if the adhesive interaction acting between the support 419 and the nanostructure 213 is greater than the adhesive interaction acting between the stamp 7 and the nanostructure 213.

In FIG. 4, stronger local forces are present between the support 419 and the nanostructures 414 than between the nanostructures 414 and the stamp 407. Thus the nanostructures 414 remain on the support 419. While not shown in FIG. 4, the nanostructures for transfer also may reside within the recessed regions 406 or may simultaneously reside on the raised regions 405 and within the recessed regions 406 of the stamp 407. In this manner, nanostructures may be created on one surface, for example the stamp 407, and then transferred to another surface, for example the support 419. Alternatively, other methods may be used to transfer the nanostructure 414 from the stamp 407, such as selectively dissolving the stamp 407 while it is in contact with the support 419, and the like.

The nanostructures and nanostructure fabrication methods of the presently claimed invention may be utilized to form many nanoscale materials. In one aspect, spectroscopic reference materials, such as for surface enhanced Raman spectroscopy, for example, may be fabricated. In another aspect, single and multi-layer photonic materials may be fabricated for use as X-Ray lithography masks, band gap structures, gratings, and optical filters. In another aspect, various patterning processes may be accomplished, including, pattern transfer to polymers and fiber optic patterning accomplished by the directed transfer of nanostructures.

The directed transfer of nanostructures may be combined with insulators, semiconductors, and metals to fabricate integrated circuits, display components, or catalysts, for example. Furthermore, the claimed devices and methods may be used functionalize the surface of various materials so they may be adapted for use as sensors, sensor arrays, optical reference materials, electrochemistry test structures, electrodes for displays, or light emitting diodes, for example. The claimed devices and methods may also be utilized in medical devices, such as in the formation of microarray chips for DNA, RNA, nucleic acids, proteins and antibodies. They may also be beneficially used to form microchannels for chemical reactors assays and sensors on chips, i.e. “lab on a chip” devices.

The preceding description is not intended to limit the scope of the invention to the preferred embodiments described, but rather to enable a person of ordinary skill in the art of nanostructure fabrication to make and use the invention. Similarly, the examples below are not to be construed as limiting the scope of the appended claims or their equivalents, and are provided solely for illustration. It is to be understood that numerous variations can be made to the procedure below, which lie within the scope of the appended claims and their equivalents.

### EXAMPLES

### Example 1

### Formation of a Polystyrene Stamp

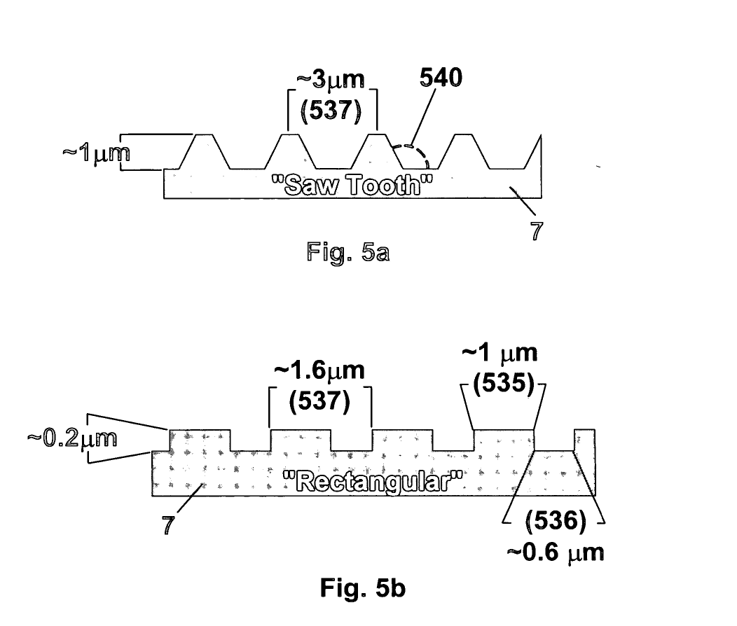

Polystyrene (PS) having a molecular weight average of 235,000 g/mol. was obtained from Scientific Polymer Products Inc. (Ontario, New York). The PS elastomeric stamp/polymer grating used for contact restricted etching and adhesive transfer of gold (Au) was molded from a “saw tooth” silicon grating (TGG01) obtained from K-TEK International Inc. (Portland, Oreg.). The silicon grating occupied a (3×3) mm² area possessing a feature dimension 537 of ˜3 μm, such as shown in FIG. 5a. Sidewall slope 540 of the “tooth” is depicted as a dashed line in FIG. 5a. The silicon grating was placed face up in an aluminum or TEFLON holding cell with ˜0.5 g of PS placed over the grating. The cell was then heated to 210° C. for ˜2 hours and allowed to cool to room temperature. The PS stamp was then separated from the silicon grating with brief sonication (<1 min.) in methanol.

### Example 2

### Formation of a Polycarbonate Stamp

The metallic layer of a commercially available compact disc (CD) was delaminated by scoring the CD surface and then vigorously rinsing with ultrapure water. The recording media was removed with a rapid methanol rinse followed by brief sonication (˜30 sec.) in a 1:4 (v/v) methanol/water solution and a final rinse in ultrapure water. The CD stamps had a “rectangular” grating structure possessing a feature dimension 537 of ˜1.6 μm, such as shown in FIG. 5b. The rectangular CD stamps also possess raised region features with a feature dimension 535 of ˜1.0 μm as well as recessed region features with a feature dimension 536 of ˜0.6 μm.

### Example 3

### Formation of a Film Coated Supporting Substrate

A 70 to 300 nm Au film was sputter coated onto a supporting substrate using a BAL-TEC MED 020 sputter coater (Liechtenstein). The Au (99.99% purity) was obtained from Techno Trade International (Manchester, N.H.). Supporting substrates coated with Au included freshly cleaved muscovite mica (Structure Probe Inc., West Chester, Pa.), glass cover-slips, glass slides, Si(100) wafer, and Si(100) wafer with a chemisorbed self-assembled monolayer (SAM) of octadecyl triethoxysilane (Gelest Inc., Morrisville, Pa.). Si(100) wafers were obtained from Virginia Semiconductor (Fredericksburg, Va.). A gold coated supporting substrate resulted.

### Example 4

### Film Compression

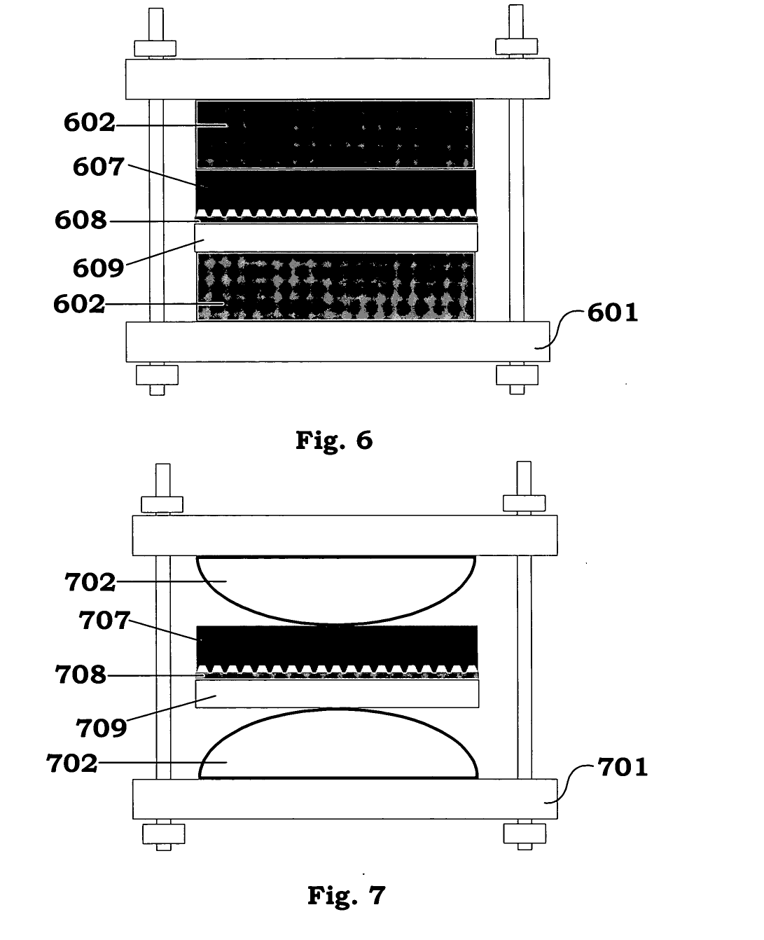

The Au coated supporting substrate from Example 3 was placed in conformal contact with the stamp of Example 1 or 2 and held together between two compression plates in a TEFLON compression cell. The compression cell is illustrated in FIGS. 6 and 7 and may include external plates, machine screws, and nuts made from a fluoropolymer, such as TEFLON. The cell may be obtained from Craftech Industries Inc., Hudson, N.Y. Two different compression plates, specifically planar compression plates 602 and curved compression plates 702, were used during nanowire fabrication. Newton's rings (interference fringes) and contact area (a) were used to optically qualify proper mating of the compression plates with the surface of the stamp and the supporting substrate.

FIG. 6 illustrates a compression cell 601 equipped with planar compression plates 602. While any suitably planar material may be used to form the compression plates 602, glass slides and glass cover cover-slips are presently preferred. The compression plates 602 may distribute the compression force in a substantially uniform manner against a polymer stamp 607 and a supporting substrate 609. In this manner, nanostructures having substantially similar average cross-sections may be formed from a gold film 608 deposited on the supporting substrate 609.

FIG. 7 illustrates a compression cell 701 equipped with the curved compression plates 702. Two convex lenses (possessing a radius of curvature of about 49 mm) may be utilized as the curved compression plates 702 to compress a polymer stamp 707 and a supporting substrate 709 against a film 708. The film 708 may be gold deposited on a supporting substrate 709 that includes mica. The curved compression plates 702 may provide a better-controlled point of contact with the stamp 707 and the supporting substrate 709.

In one aspect, a better-controlled point of contact permitted quantification of the contact radius (a), from which the normal load and pressure was estimated with Hertz contact mechanics theory. Using the curved compression plates 702 in combination with the polymer stamp 707 having “saw tooth” geometry, such as a stamp of the type illustrated in FIG. 5a, enabled production of nanostructures whose widths had a radial dependence.

The radial dependence and pressure distribution of the nanostructure widths were found to approximate what was predicted by Hertz theory. Thus, nanostructures may be fabricated with average cross-sections that increase or decrease in size as they move away from a central point, where a greater or lesser force, respectively, is exerted against the stamp 707. By varying the shape of the compression plates 702, it may be possible to control the average cross-sections and/or shape of the resultant nanostructures using a single stamp.

Prior to compression of the polymer stamp 607 or 707 against the substrate supported gold film, 608 or 708, the contact surfaces of the Au film and the polymer stamp were wet with a liquid, such as methanol (Fisher) or water. This pre-wetting suppressed bubble formation and reduced the surface tension between the water based etchant and the hydrophobic polymer stamp.

### Example 5

### Film Etching

After compression of the polymer stamp 607, 707 against the substrate supported film 608, 708, the compression cell was immersed in a 500 mL polycarbonate container and 120 ml of gold etchant solution was added. Transene gold etchant TFA (Danvers, Mass.) was diluted with ultrapure H₂O (EASYpure RF, 18.2 MΩ·cm) to increase or decrease the rate of gold etching. The volume/volume dilution ratio of TFA gold etchant to H₂O ranged from 1:1 to 1:12.5 (v/v). The etching reaction was allowed to proceed at room temperature (22 ±3° C.) or was heated (preferably less than 75° C.) with rapid stirring for ˜4-72 hours. The duration of the reaction depends on the concentration of etchant arid the temperature used.

Once the etching process has reached the desired level of completion, the stamp was removed with or without addition of a solvent, such as methanol or water, to again reduce the surface tension and facilitate separation of the two surfaces without disturbing the resulting gold nanostructures. The polymeric stamp and substrate were then gently rinsed with ultrapure H2O and dried under vacuum.

### Example 6

### Synthesis of Nanowires

When a stamp having rectangular geometry, such as a stamp of the type illustrated in FIG. 5b, is used, nanowires having an ˜400 nm diameter were formed with a 1:2 (v/v) dilution of TFA gold etchant in H₂O with a 41 hour reaction time at 22° C. and a subsequent heating for 13 hours at 65° C. Also for a rectangular stamp, nanowires having an ˜800 nm diameter were formed using a 1:2 (v/v) dilution of TFA gold etchant in H₂O with a 50 hour reaction time at 70° C.

### Example 7

### Characterization of Fabricated Nanostructures

SEM images of the resulting nanostructures (type 213 and 214 from FIG. 2) on the polymer stamp and supporting substrate were obtained with an Amray 1800 SEM (Amray Inc.).

FIG. 8 is an SEM image of the nanostructures formed in accordance with the present invention. Specifically, two separate arrays of Au nanowires, the first embedded in the recessed regions, the second on the raised regions, of two rectangular polycarbonate stamps were fabricated as a binary array. Regarding the first stamp, ˜800 nm nanowires 810 were formed, while on the second stamp, ˜400 nm nanowires 820 were formed. The image shows the ˜800 nm nanowires 810 embedded in the recessed regions of the first stamp and the raised regions 805 of the first stamp. The ˜400 nm nanowires 820 were transferred, such as by the method described with regard to FIG. 4, onto the surface of the ˜800 nm nanowires 810 at an approximate 90° angle to create a nanowire “crosshatch” pattern on the first stamp.

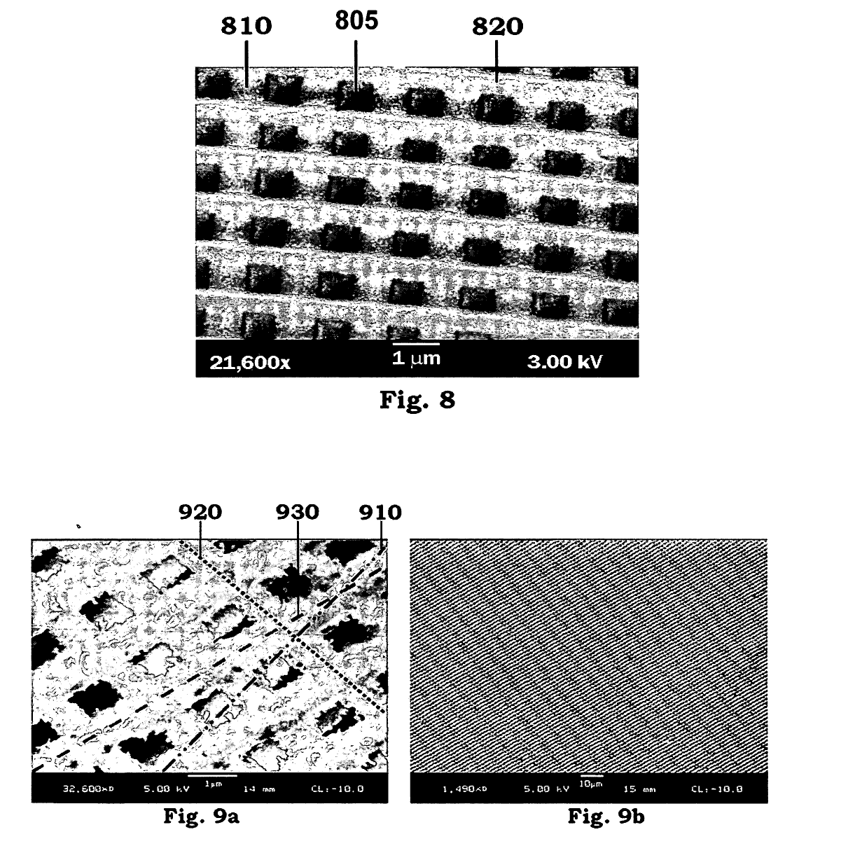

FIGS. 9a and 9b are SEM images of 3-layered crosshatch nanostructures. FIG. 9a is a near-field image depicting a 1 μm square area of the nanostructure depicted in the far-field image of FIG. 9b. Three separate procedures yielded the pictured gold arrays. The first layer of nanowires may be seen repeating along line 910 of FIG. 9a. The second layer of nanowires may be seen repeating along line 920 of FIG. 9a. The third layer of nanowires may be seen repeating along line 930 of FIG. 9a. The second and third layers were successively transferred onto the surface of the stamp, which included the first layer of nanowires.

The first layer nanowires were formed in the recessed regions of a first rectangular polycarbonate stamp by etching with a 1:12.5 (v/v) solution of TFA gold etchant in H₂O for 24 hours at 22° C. The nanowires that form the second layer were formed in the recessed regions of a second rectangular polycarbonate stamp and were transferred onto the nanowires residing in the recessed regions of the first polycarbonate stamp. The second layer nanowires were formed in the second stamp by etching with a 1:2 (v/v) solution of TFA gold etchant in H₂O for 44.5 hours at 22° C. The nanowires that form the third layer were formed in the recessed regions of a third rectangular polycarbonate stamp and were transferred onto the second layer of nanowires. The third layer nanowires were formed in the third stamp by etching with a 1:2 (v/v) solution of TFA gold etchant in H₂O for 43.5 hours at 22° C. and for 1.5 hours at 65° C.

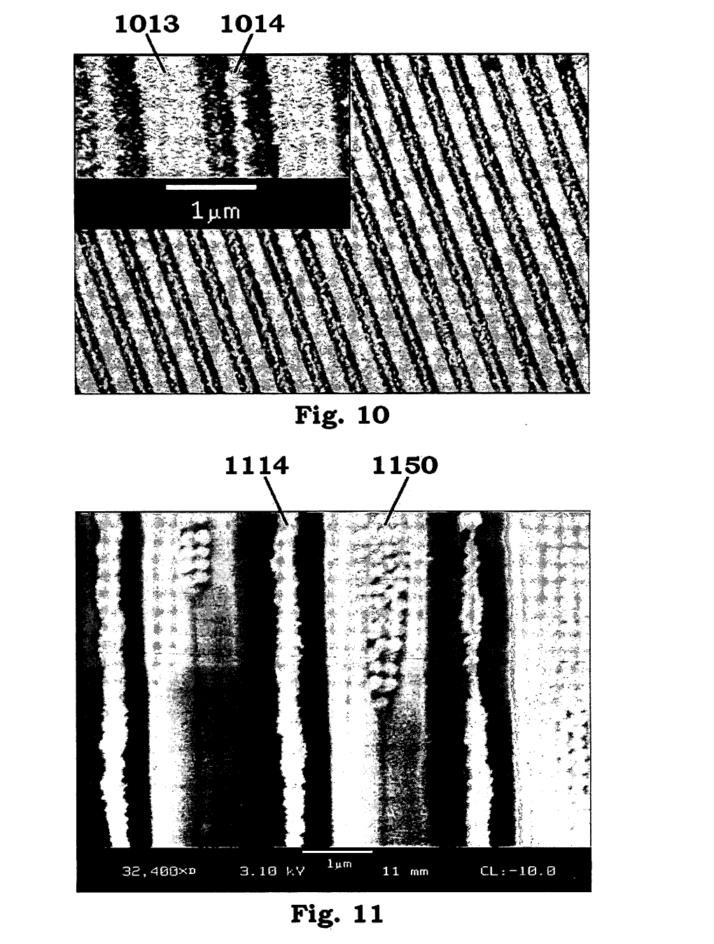

FIG. 10 is an SEM image of a binary gold nanowire array. A rectangular polycarbonate stamp was used to form ˜900 nm nanowires 1013 residing in the recessed regions of the stamp and ˜130 nm nanowires 1014 residing on the raised regions of the stamp. Both sets of nanowires were simultaneously formed by etching with a 1:12.5 (v/v) dilution of TFA gold etchant in H₂O for 24 hours at 22° C.

FIG. 11 is an SEM image of a nanostructure including a gold nanowire array and colloidal polystyrene spheres. A compression cell equipped with curved compression plates was used with a saw tooth stamp to produce the array. After compression of the gold film, etching was conducted with a 2:3 (v/v) dilution of TFA gold etchant in H₂O for 48 hours at 70° C. to form ˜200 nm gold nanowires 1114 residing on the raised regions of the saw tooth polystyrene stamp. Colloidal polystyrene spheres 1150, having average diameters of ˜200 nm, were solution deposited into the recessed regions of the stamp. The SEM image established that the Au nanowires resided on the raised regions of the stamp.

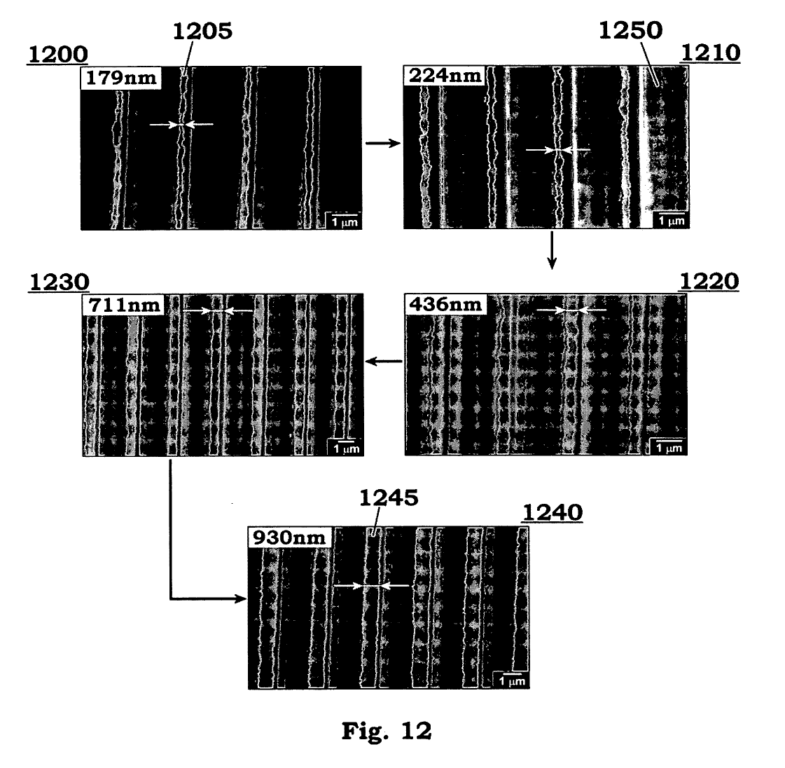

FIG. 12 includes SEM images establishing that the pressure distribution and geometric etch anisotropy can be used in combination to radially modulate the average cross-sections of the formed nanostructures. A compression cell equipped with curved compression plates was used with a saw tooth stamp to produce the gold nanowire array. After compression of the gold film, etching was conducted with a 2:3 (v/v) dilution of TFA gold etchant in H₂O for 48 hours at 70° C. The SEM images 1200-1240 reveal a radial variation of the average cross-section of the Au nanowires. The images show the gradual average cross-section width increase of the nanowires 1205 from ˜180 nm at the outer edge of the stamp—film contact, to nanowires 1245 having an average cross-section width of ˜900 nm at the contact center where the largest force is applied to the stamp by the curved compression plates. Colloidal polystyrene spheres 1250 established that the Au nanowires resided on the raised regions of the stamp.

As any person of ordinary skill in the art of fabrication of nanostructures will recognize from the provided description, Figures, and examples, modifications and changes can be made to the preferred embodiments of the invention without departing from the scope of the invention defined by the following claims and their equivalents.

1. A method for fabricating nanostructures, comprising:
(a) contacting a stamp having a plurality of raised regions and a plurality of recessed regions with a film, thus forming a plurality of contacts between the stamp and the film, where the film resides on a supporting substrate;
(b) compressing the stamp into the film to form a plurality of deformations in the film;
(c) flowing at least one chemical reagent through at least one of an upper channel formed between the stamp and the film and a lower channel formed between the film and the supporting substrate to chemically modify at least a portion of the film; and
(d) separating the stamp from the film, where the nanostructures are formed from the film.

2. The method of claim 1, where steps a through d are repeated.

3. The method of claim 1, where the compressing applied to the stamp includes the use of one or more curved compression plates.

4. The method of claim 1, where the smallest feature dimension of the stamp is from 1 to 5000 nm.

5. The method of claim 1, where the stamp includes at least one of a polymer, a co-polymer, and a polymer composite.

6. The method of claim 1, where the stamp includes at least one of poly(methyl methacrylate), polybutadiene, polystyrene, and polycarbonate.

7. The method of claim 1, where the stamp is made from a material having a Young's Modulus of at least 10⁷ Pa.

8. The method of claim 1, where the stamp is made from a material having a Young's Modulus from 10⁸ to 10¹⁰ Pa.

9. The method of claim 1, where the stamp includes at least one of sloped sidewall and rectangular sidewall geometry.

10. The method of claim 1, further comprising exposing the stamp to radiation.

11. The method of claim 1, where the film includes metal.

12. The method of claim 1, where the film includes gold.

13. The method of claim 1, further comprising depositing the film on the supporting substrate.

14. The method of claim 1, where the supporting substrate includes at least one of a solid, a porous solid, muscovite mica, silicon, and glass.

15. The method of claim 1, where the compressing of the stamp into the film to form a plurality of deformations in the film further comprises cutting through at least a portion of the film.

16. The method of claim 1, where the plurality of deformation in the film include at least one of an elastic deformation and a plastic deformation.

17. The method of claim 1, where the stamp undergoes at least one of an elastic deformation and a plastic deformation.

18. The method of claim 1, where the chemical modifying includes a partial removal of the film.

19. The method of claim 1, where the at least one chemical reagent includes a metal etchant.

20. The method of claim 1, where after separating the stamp from the film, at least a portion of the nanostructures reside on the supporting substrate.

21. The method of claim 1, where after separating the stamp from the film, at least a portion of the nanostructures reside on the stamp.

22. The method of claim 1, where the nanostructure is a wire.

23. The method of claim 1, further comprising incorporating the nanostructures into a device.

24. The method of claim 1, where the nanostructures reside on at least one of the raised regions and the recessed regions of the stamp.

25. The method of claim 24, where the nanostructures reside on both the raised regions and the recessed regions of the stamp.

26. The method of claim 24, further comprising transferring at least a portion of the nanostructures to a support.

27. The method of claim 26, where the transferring includes a plurality of transfers to form at least one of a multi-dimensional architecture, a three-dimensional architecture, a binary array architecture, and a multilayered three-dimensional architecture.

28. The method of claim 1, where the nanostructures have an average cross-section from 1 nm to 1 μm.

29. The method of claim 1, where the nanostructures have an average cross-section from 1 nm to 500 nm.

30. The method of claim 1, where the nanostructures have an average cross-section from 50 nm to 1 μm.

31. The method of claim 1, where the nanostructures have an average cross-section of less than 120 nm.

32. A device including the nanostructures formed by the method of claim 1, where the device is at least one of a stamp, a photonic device, a band-gap device, and an X-Ray stencil, where the X-Ray stencil is suitable for use in a photolithography process.

33. A method of patterning a surface, comprising:
(a) contacting a stamp having a plurality of raised regions and a plurality of recessed regions with a film residing on a supporting substrate to form a plurality of contacts between the stamp and the film;
(b) compressing the stamp into the film to form a plurality of deformations in the film;
(c) flowing at least one chemical reagent through at least one of an upper channel formed between the stamp and the film and a lower channel formed between the film and the supporting substrate to chemically modify at least a portion of the film; and
(d) separating the stamp from the supporting substrate, where at least a portion of the nanostructures formed from the film remain embedded in the stamp; then
(e) transferring the stamp including the embedded nanostructures on a photoresist;
(f) introducing radiation to the stamp, where only a portion of the radiation contacting the stamp passes through the stamp and reaches the photoresist.
